(19) United States
(12) Patent Application Publication
(10) Pub. No.: US 2017/0329526 A1
(43) Pub. Date: Nov. 16, 2017

(54) INTEROPERABLE CAPABILITIES

(71) Applicant: Hewlett Packard Enterprise Development LP, Houston, TX (US)

(72) Inventors: Reto Achermann, Zurich (CH); Maurice Bailleu, Dresden (DE); Dejan S. Milojicic, Palo Alto, CA (US); Gabriel Parmer, Palo Alto, CA (US)

(21) Appl. No.: 15/154,629

(22) Filed: May 13, 2016

(51) Int. Cl. G06F 3/06

(52) U.S. Cl. CPC G06F 3/065; G06F 3/0683; G06F 3/0604; G06F 3/0611

(57) ABSTRACT

Example implementations relate to an interoperable capability. For example, in an implementation, an interoperable capability is recognizable by a plurality of kernels of a system, and the interoperable capability references a local capability of respective kernels. Consistency among the local capabilities of the kernels and the interoperable capability is maintained, in response to operations invoked on the interoperable capability.

### BACKGROUND

Capabilities may be employed by operating system kernels to represent, address, and grant access to system and user level objects or resources, such as memory, threads and tasks, system devices, and the like. Capabilities of different operating system kernels may differ in terms of formatting, semantics, operations supported, guarantees, or other aspects.

### BRIEF DESCRIPTION OF THE DRAWINGS

Various examples will be described below with reference to the following figures.

FIG. 1 is a block diagram that depicts an example system that employs an interoperable capability, according to an implementation.

FIG. 2 is a block diagram that depicts an example system that employs interoperable capabilities, according to an implementation.

FIG. 3A depicts an example interoperable capability that references local capabilities, according to an implementation.

FIG. 3B depicts an example interoperable capability that references local capabilities, according to another implementation.

FIG. 3C depicts an example interoperable capability that references local capabilities, according to another implementation.

FIG. 4 is a flow diagram depicting an example method for creating an interoperable capability, according to an implementation.

FIG. 5 is a flow diagram depicting an example method for integrating an interoperable capability, according to an implementation.

FIG. 6 is a flow diagram depicting an example method for revoking an interoperable capability, according to an implementation.

FIG. 7 is a flow diagram depicting an example method for maintaining an interoperable capability, according to an implementation.

FIG. 8 is a block diagram of an example multi-computer system that includes a non-transitory, machine readable medium encoded with example instructions to establish an interoperable capability, according to an implementation.

Throughout the drawings, identical reference numbers may designate similar, but not necessarily identical, elements. A hyphenated index number “N” appended to some of the reference numerals may be understood to merely denote plurality and may not necessarily represent the same quantity for each reference numeral having such an index number “N”. Additionally, use herein of a reference numeral without a hyphenated index number, where such reference numeral is referred to elsewhere with a hyphenated index number, may be a general reference to the corresponding plural elements, collectively or individually.

### DETAILED DESCRIPTION

Multi-computers may include a plurality of nodes, each of which may have dedicated memory. Some multi-computers may employ persistent memory, and more particularly, a pool of persistent memory that is accessible by the nodes in addition to dedicated memory. Operating systems and kernels may be run on the nodes, and in some cases, different types, versions, or instances of kernels may be run on different nodes. Such a multi-computer that runs multiple operating system kernels may also be referred to as a multi-kernel or multi-operating system computer. Nodes may communicate with each other via distributed inter-node communication over a fabric. In some instances, a virtual environment with multiple virtual machines and a hypervisor may emulate a multi-computer with multiple nodes running multiple operating system kernels.

Some operating system kernels may employ capabilities to represent, address, and grant access to resources of the multi-computer. Access to a capability may imbue a kernel process or application process with a right to perform specific actions on an associated resource. A resource may include aspects of the multi-computer such as byte-addressable memory, threads and tasks, protection domains, representations of CPU time, system calls, networking bandwidth or throughput, system devices, and the like. However, capabilities of different operating system kernels (e.g., different in type, version) may differ in terms of formatting, semantics, operations supported, guarantees, or other aspects. Accordingly, it may be useful to provide for interoperability of capabilities between different operating system kernels, particularly in a multi-computer environment with persistent memory.

Examples disclosed herein may relate to, among other things, an interoperable capability. In some implementations, the interoperable capability is accessible to and recognizable by each kernel of a plurality of operating system kernels running on a system, such as a multi-computer. The interoperable capability references associated local capabilities at respective kernels. Operations invoked by the kernels on the interoperable capability are mediated to achieve consistency among the local capabilities of the kernels and the interoperable capability. In some implementations, the interoperable capability may store a constraint or guarantee on usage of a resource, the constraint or guarantee to be observed by each kernel when using the interoperable capability.

By virtue of an interoperable capability, resources may be tracked and access-mediated across different operating system kernels running on different nodes of a multi-computer (or running on virtual machines in a virtual environment). Additionally, interoperable capabilities may be stored in persistent memory to become long-lived, thus enabling capabilities to live across system reboots, to be re-used, or to be accessed by different kernels. Moreover, interoperable capabilities allow for capabilities to be transferred safely and with consistency between different environments.

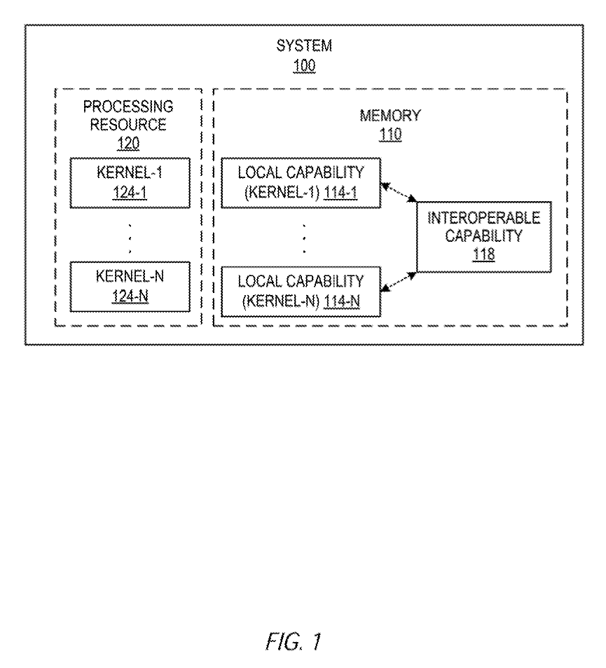

Referring now to the figures, FIG. 1 is a block diagram that depicts an example system 100 that employs an interoperable capability, according to an implementation. The system 100 includes a memory 110 and a processing resource 120.

The processing resource 120 may be one or many of a microcontroller, a microprocessor, central processing unit (CPU) core, an application-specific integrated circuit (ASIC), a field programmable gate array (FPGA), and/or the like. The processing resource 120 may retrieve and/or execute instructions. In some implementations, the processing resource 120 may be heterogeneous in nature, in that the processing resource 120 includes CPU cores (and/or other types of processing resource) that differ in instruction set architectures supported, performance characteristics, or other aspects.

In some implementations, the system 100 may be a multi-computer or rack-scale computer that includes a network of independent nodes or cores (in which case, the nodes may comprise the processing resource 120). The system 100 may be capable of running multiple operating systems and associated operating system kernels on the nodes concurrently. For example, as depicted in FIG. 1, the processing resource 120 may run an N-plurality of kernels, including kernel-1 124-1 through kernel-N 124-N (also referred to collectively as “kernels 124” or individually as a “kernel 124”). A kernel is a set of machine readable instructions that is executed by the processing resource 120 and may function as an interface between resources of the system 100 (e.g., processing, memory, and networking resources, etc.) and an associated operating system and/or applications. The kernels 124 may be of different types or versions, or may be different instances of the same operating system type.

The memory 110 may include any volatile memory (e.g., dynamic random access memory or DRAM, static random access memory or SRAM, etc.) and/or persistent memory formed from non-volatile memory devices (e.g., flash memory devices, phase-change memory devices, spin-transfer torque memory devices, resistive random-access memory or memristive devices, etc.). In some implementations, some portions of memory 110 may be local to and accessible to respective kernels 124, while other portions of memory 110 may be shared by and accessible to all kernels 124.

The memory 110 may store an interoperable capability 118 and local capabilities 114-1 through 114-N (also referred to collectively “local capabilities 114” or individually as a “local capability 114”). As described above, a capability imbues the right to perform actions on a resource of system 100. Each local capability 114 belongs to a respective kernel 124 and is formatted in a representation specific to the respective kernel 124, although some local capabilities 124 may share commonalities. For example, local capability 114-1 belongs to kernel-1 124-1 and local capability 114-N belongs to kernel-N 124-N. The interoperable capability 118 is accessible by the plurality of operating system kernels 124.

The interoperable capability 118 references the local capability 114 of each kernel 124. The processing resource 120 runs the kernels 124, and each kernel 124 maintains a mapping of the local capability 114 of that kernel 124 to the interoperable capability 118. For example, kernel-1 124-1 maintains a mapping of its local capability 114-1 to the interoperable capability 118. The references between the interoperable capability 118 and the local capabilities 114 are depicted by the dotted arrows in FIG. 1.

The processing resource 120 (and more particularly, the kernels 124) also maintains consistency among the local capabilities 114 of the kernels 124 and the interoperable capability 118 in response to invocation of an operation on the interoperable capability 118. That is, consistency is maintained between the local capabilities and also between the interoperable capability and the local capabilities. For example, operations may include creating, deleting, or modifying capabilities, among other operations.

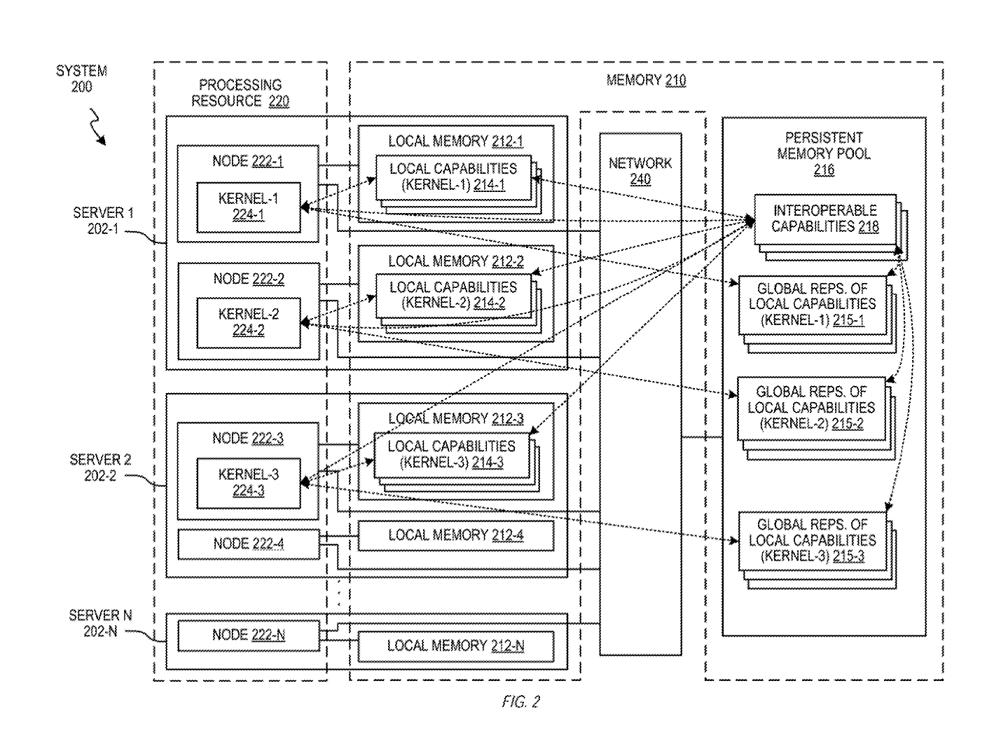

FIG. 2 is a block diagram that depicts an example system 200 that employs interoperable capabilities, according to an implementation. The system 200 includes a memory 210 and a processing resource 220. The system 200 may be a multi-computer having a plurality of nodes 222-1 through 222-N (also referred to collectively as “node 222” or individually as a “node 222”). The nodes 222 may form the processing resource 220 portion of the system 200. In some implementations, each node 222 may be or include CPU core(s), a microcontroller, a microprocessor, an ASIC, a system-on-a-chip (SoC), etc. The nodes 222 may be heterogeneous, in that some nodes 222 may be different types of processing resources that support different instruction set architectures, provide different performance characteristics, or differ in other aspects. In some implementations, individual or plural nodes 222 may be organized onto servers that form part of the system 200. For example, as depicted in FIG. 2, the nodes 222-1 and 222-2 reside on a first server 202-1 and the nodes 222-3 and 222-4 reside on a second server 202-2. Each of the nodes 222 may communicate with each other by way of a fabric, such as a network 240. It should be understood that more or less nodes and servers may be employed than is shown and described with respect to the example illustrated in FIG. 2.

The memory 210 of the system 200 refers to local memory 212-1 through 212-N (also referred to collectively or individually as “local memory 212”) and a persistent memory pool 216. For example, the local memory 212 may be volatile memory (e.g., DRAM), and each local memory 212 may be coupled to or integrated with a respective node 222 (e.g., an SoC node may include both a processing portion and local memory in an integrated package). To illustrate, local memory 212-1 may be local DRAM memory coupled to and accessible solely by the node 222-1. The persistent memory pool 216 portion of the memory 210 may be formed from non-volatile memory devices (e.g., flash memory devices, phase-change memory devices, spin-transfer torque memory devices, resistive random-access memory or memristive devices, etc.) and may be accessible to all nodes 222, by way of the network 240 fabric for example.

As with system 100, the system 200 may support multiple kernels. A plurality of operating system kernels may be run on at least some respective nodes 222. In the example depicted in FIG. 2, a kernel-1 224-1 runs on the node 222-1, a kernel-2 224-2 runs on the node 222-2, and a kernel-3 224-3 runs on the node 222-3. Although three kernels are shown in FIG. 2 (also referred to collectively as the “kernels 224” or individually as a “kernel 224”), it should be understood that the system 200 may run more or fewer kernels. In some instances, a node 222 need not run a kernel (e.g., the node may be idle or unused). The kernels may be different types (e.g., L4, Barrelfish, Composite, Keykos, Mach, CHERI, etc.), different versions of the same type, or different instances of the same kernel.

In particular, the kernels 224 may support kernel capabilities that imbue rights to perform specific actions on resources of the system 200, such as memory resources (e.g., access to a particular base plus length), networking resources (e.g., throughput or bandwidth), processing resources (e.g., threads, CPU time, system calls, etc.). In some implementations, the system 200 also may permit nodes to run operating systems and kernels that do not support capabilities. A kernel that supports kernel capabilities creates one or more local capabilities formatted in a representation specific to that kernel and stored in a portion of memory local to that kernel. Such capability creation may be the result of user rights-based access mediated by the operating system and/or kernel. In the example of FIG. 2, the kernel-1 224-1 may create local capabilities 214-1 stored in local memory 212-1, the kernel-2 224-2 may create local capabilities 214-2 stored in local memory 212-2, and the kernel-3 224-3 may create local capabilities 214-3 stored in local memory 212-3.

Some kernels 224 may be capable of creating global representations of their local capabilities in the persistent memory pool 216 shared by all nodes 222. For example, kernel-1 may create global representations 215-1 of the local capabilities 214-1, kernel-2 may create global representations 215-2 of the local capabilities 214-2, and kernel-3 may create global representations 215-3 of the local capabilities 214-3, although it should be understood that kernels may create global representations for none, some, or all of that kernel's local capabilities. Global representations of local capabilities may be useful in various circumstances, such as providing information that is specific to an individual kernel but which may also benefit other kernels or as in a case where two same kernels (i.e., same type and version) run on different nodes but could share a capability via a global representation. The local capabilities and global representations of local capabilities may be referred to collectively as local capabilities 214 and global representations 215, respectively, or individually as a local capability 214 or a global representation 215, respectively.

In addition to handling local capabilities 214 and global representations 215 of local capabilities, the kernels 224 may be extended or designed to support interoperable capabilities and related functionality as described herein. The kernels 224 may interact, as pertains to interoperable capabilities, via distributed inter-node communication or messaging over the network fabric 240.

For example, the kernels 224 may create, modify, and revoke an interoperable capability 218 stored in a persistent and shared portion of the memory 210 accessible to all of the kernels 224, namely in the persistent memory pool 216. The kernels 224 may invoke operations that affect the interoperable capability 218, and the kernels 224 may also maintain consistency among the local capabilities 214 and the interoperable capability 218 in relation to the invoked operations. Kernels 224 may also associate or map their respective local capability 214 with an existing interoperable capability 218 (e.g., created by another kernel), although every local capability 214 of a kernel 224 need not be associated with an interoperable capability 218. Interoperable capabilities 218 and local capabilities 214 both refer to or are associated with resources of the system 200. In some implementations, interoperable capabilities 218 refer to shared resources of the system 200 and do not refer to local resources, that is, resources that are not accessible by some kernels 224.

In some implementations, multiple interoperable capabilities 218 may be stored in the memory 210, and more particularly, in the persistent memory pool 216. By virtue of being stored in the persistent memory pool 216, the interoperable capabilities 218 are accessible by and shared between each of the plurality of kernels 224, and also may persist (i.e., remain available) across reboots of the system 200.

An interoperable capability may have any combination of the following non-exhaustive list of properties. A “provenance” property may describe what operating system type and version supports the interoperable capability natively. A “resource represented” property may describe the resource or action or service of the system 200 to which rights are granted by the interoperable capability. An interoperable capability may have a “type” property related to the resource associated with the capability (e.g., a “Frame” type for mappable memory, a “DevFrame” type referring to memory-mapped I/O of a device, or an “Endpoint” type for a communication endpoint, among other possible types). A “liveness” property may describe lifetime constraints, such as an expiration date or lifespan, a maximum or minimum number of references to the associated resource, a garbage collection behavior when the last reference to a kernel's local capability is gone, etc. A “persistence” property may indicate the persistency (e.g., continued availability across reboots) of the interoperable capability and/or the associated resource. A “quality of service” (QoS) property may describe real-time operational constraints or requirements related to the interoperable capability or to associated resources. An “ownership” property may indicate who (e.g., which kernel) owns the capability and the associated resource. An “authority” property may indicate which entities (e.g., kernels) are entitled to manipulate the interoperable capability, which can be limited to the owner but not necessarily so. An “access rights” property may indicate what operations can be executed on the interoperable capability and/or the associated resources. “Addressing” properties may relate to the distinct memory regions and unique addresses thereof where the interoperable capability is stored. Interoperable capabilities affecting physical resources of the system 200, such as memory or CPU time for example, may be derived according to a predefined set of rules, and as such, there may be a bootstrapped genesis capability for each resource type that forms the root of a derivation tree. The genesis capability may refer to all physical addressable resources of a node or node(s).

An interoperable capability 218 and its associated properties may be formatted, at least in part (e.g., a generic part), in a representation that is interpretable by each kernel 224 that supports interoperable capabilities. To illustrate, an example memory layout of an interoperable capability 218 may be formatted as follows:

```
struct interop_cap {
    struct caphdr header;
    union {
        struct memcap memory;
        struct qoscap dos;
        struct svccap service;
        ...
    } resourceinfo;
    struct capset locals;
};
```

In the above example “interop_cap” of an interoperable capability 218, a header “caphdr” contains metadata about the type property, the persistence property, and/or other properties of the interoperable capability described above. The interoperable capability also holds “resourceinfo” metadata that details the resource-specific information used to perform actions on the resource of system 200.

Some resource-specific metadata included in the interoperable capability 218 may relate to a guarantee. A guarantee may be a constraint on usage of the interoperable capability 218 (and thus the associated system resource) to be observed by each kernel when the kernel utilizes the interoperable capability 218. For example, guarantees may relate to liveness, persistence, QoS, etc. To establish a guarantee, an interoperable capability 218 may store in metadata a representation of a resource of the system 200 to be governed by the guarantee and also may store a constraint (i.e., the guarantee) on usage of that resource.

For example, resources that may be governed by guarantees may include a budget, a relative weighted fairness, a priority, etc., and such resources may be in units of time (e.g., CPU time), throughput (e.g., network throughput), bandwidth (e.g., network bandwidth), etc. To illustrate, a kernel accessing system resources via capabilities may consume budgeted CPU time at a specified priority, or may consume a networking budget to send packets. The nature of the constraint stored in the interoperable capability 218 may depend on the resource involved, and may include a specified deadline, a QoS, a service level agreement (SLA), etc. In operation, when a particular kernel 224 seeks to access a local capability 214 and thus a system resource associated with that capability, the kernel 224 may refer to the mapped interoperable capability 218 to determine if there are guarantees to be observed.

In an illustrative implementation of guarantees, a kernel or application process may have a capability to access a CPU core, and the corresponding interoperable capability may dictate a budget of CPU time for that process to execute on the CPU core. If the process spawns a new child process, the parent process provides the child process with a share of the budgeted CPU time. The parent process may pass the capability to its child processes to share a CPU time slot.

In another implementation of guarantees, a kernel or application process may have a capability to access network bandwidth to send or receive packets, and the corresponding interoperable capability may dictate the network bandwidth allotted to the process for sending or receiving packets. The network bandwidth may be shared by passing the capability.

In another implementation of guarantees, the system 200 may comprise a virtual environment having virtual machines and a hypervisor (e.g., the nodes 222 may be virtual machines), and the kernels 224 may run on the virtual machines. In such a configuration, the hypervisor may employ interoperable capability guarantees to cooperatively multiplex system resources among the virtual machines. Each kernel is allotted resources by the hypervisor, and each kernel may pass capabilities to other kernels or virtual machines to enable cooperative usage of the physical system resources.

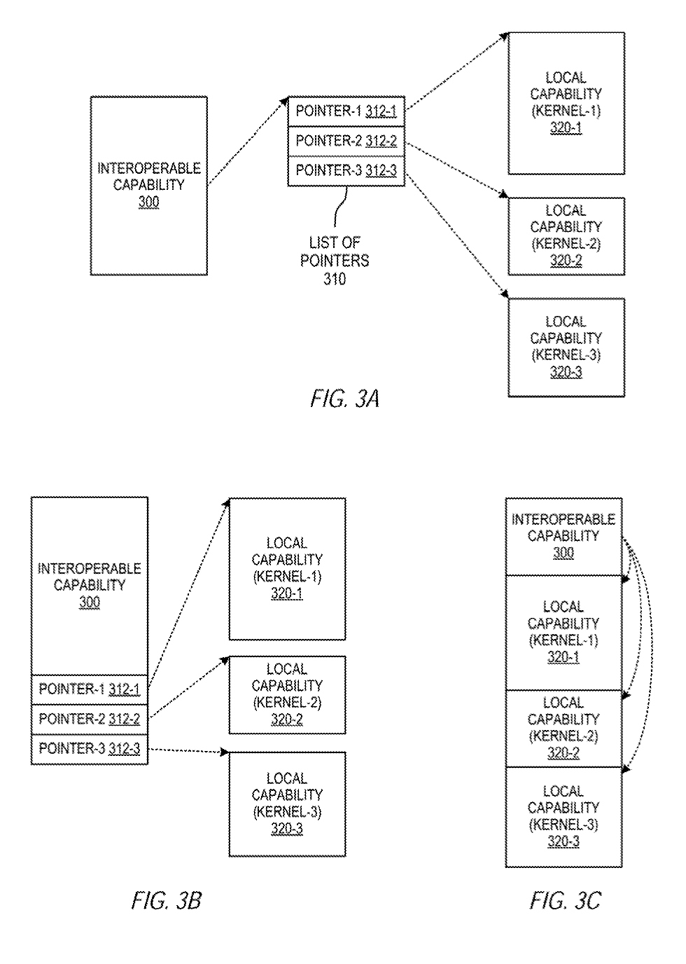

An interoperable capability 218 also may include a set of references to the local capabilities that are acted on by each individual kernel (e.g., references stored as “capset”, in the above example memory layout of an interoperable capability). Such references are depicted in FIG. 2 by dotted arrows between the interoperable capabilities 218 and the local capabilities 214, as well as between the interoperable capabilities 218 and the global representations 215. Example implementations of referencing formats will now be described with reference to FIGS. 3A, 3B, and 3C, each of which may have different performance or encapsulation characteristics.

FIG. 3A illustrates a fixed interoperable capability format, in which an interoperable capability 300 is of a fixed size and includes a reference to a list 310 (or an array) of pointers. The pointers 312-1, 312-2, 312-3 in the list 310 reference or point to local capabilities 320-1, 320-2, 320-3 respectively, which belong respectively to kernel-1 320-1, kernel-2 320-2, and kernel-3 320-3. The fixed size of the interoperable capability 300 illustrated in FIG. 3A may be useful to facilitate implementation in hardware (i.e., hardware-supported capabilities).

FIG. 3B illustrates an expandable interoperable capability format, in which pointer references 312-1, 312-2, 312-3 to respective local capabilities 320-1, 320-2, 320-3 are inlined into an interoperable capability 300. The expandable capability format illustrated in FIG. 3B may be useful for reducing the level of indirection (i.e., the use of references or pointers) and the number of memory accesses associated with the implementation described in FIG. 3A. In some implementations, the number of pointers that are inlined in the example of FIG. 3A may be limited to a maximum number, with additional references being placed in a separate list or array in a manner similar to the list 310 described above.

FIG. 3C illustrates a self-describing interoperable capability format, in which local capabilities 320-1, 320-2, 320-3 themselves are inlined into an interoperable capability 300. Metadata may be utilized in the interoperable capability 300 to distinguish and identify each inlined local capability 320-1, 320-2, 320-3. Inlining the local capabilities 320-1, 320-2, 320-3 avoids needing to resolve references, and may be useful in systems where there is insufficient shared memory to support capabilities crossing system boundaries (e.g., for access by different instances of a particular kernel type).

Referring again to FIG. 2, the processing resource 220 (e.g., the nodes 222) run the kernels 224. Each kernel (e.g., 224-1) maintains a mapping of the local capability (e.g., 214-1) of that kernel (e.g., 224-1) to the interoperable capability (218). That is, a kernel (e.g., 224-1) tracks whether, for a given one of its local capabilities (e.g., 214-1), an interoperable capability 218 exists and at what memory address it is located in the persistent memory pool 216. In some implementations, each kernel 224 maintains at most one mapping to a particular interoperable capability 218.

The kernels 224 also maintain consistency among the local capabilities 214 of the kernels 224 and the interoperable capability 218 (i.e, local capability to local capability consistency, as well as consistency between local capability and interoperable capability), in response to invocation of an operation on the interoperable capability 218. For example, operations can be performed on interoperable capabilities, as well as local capabilities, to manipulate their state, and operations may include: a “Retype” operation to create a new interoperable capability from an existing one by retyping the existing interoperable capability or a sub-region thereof; a “Delete” operation to delete the interoperable capability or a subtree of resources and capabilities rooted at the interoperable capability; a “Revoke” operation to delete existing sibling or descendants of the interoperable capability; a “TypeCheck” operation to ascertain the type of the interoperable capability; a “Mint” operation to create a new interoperable capability based on the existing interoperable capability (e.g., of the same type and with equal or reduced set of rights); an “Enumerate” operation to retrieve a list of all related interoperable capabilities (e.g., siblings and/or descendants); “CapArrayRefGet” and/or “CapArrayRefSet” operation(s) to perform get and set commands on a reference of the interoperable capability to a local capability; an “OperationSupported” operation to check if a given operation is supported; an “InteroperableSet” and/or “InteroperableRemove” operations to set the interoperable capability as being in a committed state such that it is interoperable and another kernel can interact with it or to remove the interoperability, respectively; a “MapLocal” operation to map the interoperable capability to a local capability; a “TransferOwnership” operation to transfer ownership of the interoperable capability to another kernel; and “Grant” and/or “Revoke” operations to modify authority rights of kernels to perform various operations; as well as other operations. As described above, metadata of interoperable capabilities 218 determine whether a given kernel 224 is permitted to perform various ones of the foregoing operations.

Various techniques may be employed, by the processing resource 220 and more particularly by the kernels 224, for achieving, mediating, and maintaining consistency between the interoperable capability 218 and the local capabilities 214 (including global representations 215) and among the local capabilities 214 (and global representations 215) when operations are invoked, such as when a particular kernel seeks to invoke an operation on a local capability that is associated with an interoperable capability and thus has repercussions on the shared resources of the system 200. For example, changing a QoS may have repercussions that affect some or all kernels 224. Various techniques will now be described.

In some implementations, consistency may be maintained by achieving consensus among the kernels 224 to execute the operation. For example, the kernels 224 may employ consensus protocols. More particularly, the kernels 224 having authority with respect to the interoperable capability 218 on which an operation is invoked may form nodes in a consensus system. By way of the consensus protocols, the authority kernels can agree whether to execute the operation, and in the case of multiple operations, the order in which the operations are to be executed. Upon reaching consensus, each kernel implements changes to their respective local capabilities 214 and global representations 215 affected by the operation on the interoperable capability 218.

In some implementations, consistency may be maintained by forwarding invocation of the operation to a capability owner from among the kernels 224. The capability owner may be a kernel with authority to execute the operation on the interoperable capability 218, as indicated by the ownership property in the metadata of the interoperable capability 218 (and/or the authority property in some implementations). Thus, the owner controls execution of operations on the interoperable capability 218 and also instructs the other kernels 224 to implement changes to their respective local capabilities 214 and global representations 215 affected by an operation on the interoperable capability 218.

In some implementations, consistency may be maintained by enforcing each of the kernels 224 to execute the operation on their respective local capabilities 214. In other words, when one kernel (e.g., 224-1) invokes an operation on a local capability (e.g., 214-1) affecting an interoperable capability 218, all other kernels (e.g., 224-2, 224-3) that reference that interoperable capability 218 are compelled to execute the same or similar operation on their own respective local capability (e.g., 214-2, 214-3) and global representation (e.g., 215-2, 215-3).

In implementations where the system 200 comprises a virtual environment, capabilities may be owned by the hypervisor, and the kernels 224 may invoke the capabilities using hypercalls. The hypervisor acts as the authority, and all operations may be executed on the capabilities in an interoperable format. Resources may be shared between virtual machines and between kernels 224 by passing the capability via the hypervisor. By virtue of capability authority vested in the hypervisor, capabilities may be inherently consistent.

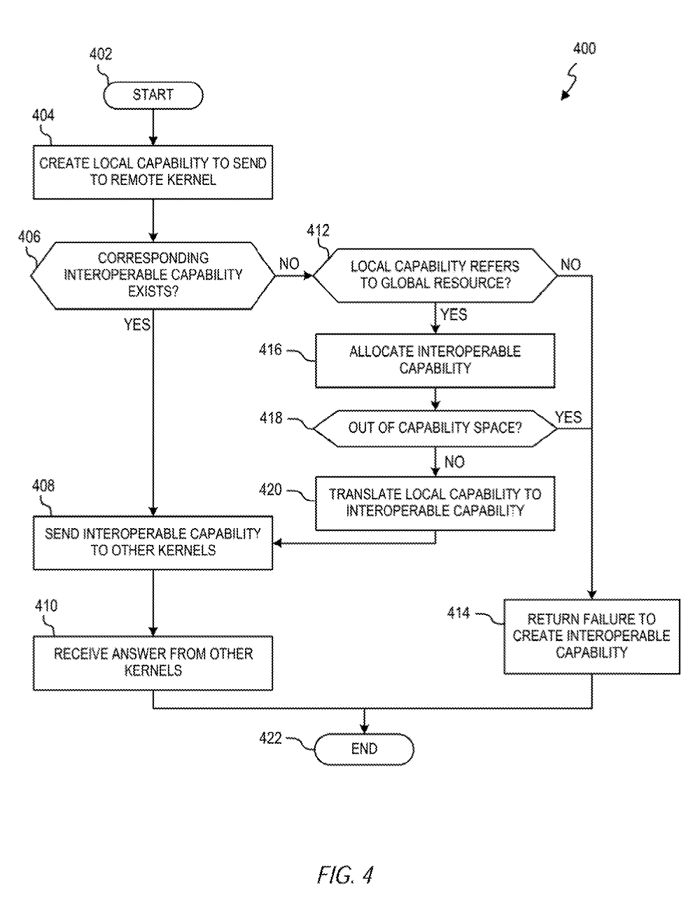

FIGS. 4, 5, and 6 depict example methods of various operations involving interoperable capabilities. Each of the methods may be executed according to a consistency achieving technique described above, such as implementation of a consensus protocol among kernels, forwarding invoked operations to an owner kernel, or enforcing all kernels to execute operations.

FIG. 4 is a flow diagram depicting an example method 400 for creating an interoperable capability, according to an implementation. Method 400 may be implemented in the form of executable instructions stored on a machine readable medium and executed by a processing resource (e.g., a microcontroller, a microprocessor, central processing unit core(s), an ASIC, an FPGA, etc.) and/or in the form of electronic circuitry. For example, method 400 may be described below for illustrative purposes as being performed by kernels 224 running on the processing resource 220 (comprising nodes 222) of system 200 and communicating via inter-node messaging, although method 400 may also be performed by other devices, such as kernels 124 running on the processing resource 120. In some implementations, one or more blocks of method 400 may be executed substantially concurrently or in a different order than shown in FIG. 4. In some implementations, method 400 may include more or fewer blocks than are shown in FIG. 4. In some implementations, one or more of the blocks of method 400 may, at certain times, be ongoing and/or may repeat.

Method 400 may begin at block 402, and continue to block 404, where a kernel (e.g., 224-1) creates a local capability (e.g., 214-1) that is to be sent to other kernels (e.g., 224-2, 224-3). Interoperability becomes implicated by virtue of sending the local capability to other kernels. At block 406, the kernel (224-1) determines whether an interoperable capability (e.g., 218) corresponding to the local capability (214-1) created at block 404 already exists. For example, another kernel may have previously created a similar or same local capability and interoperable capability.

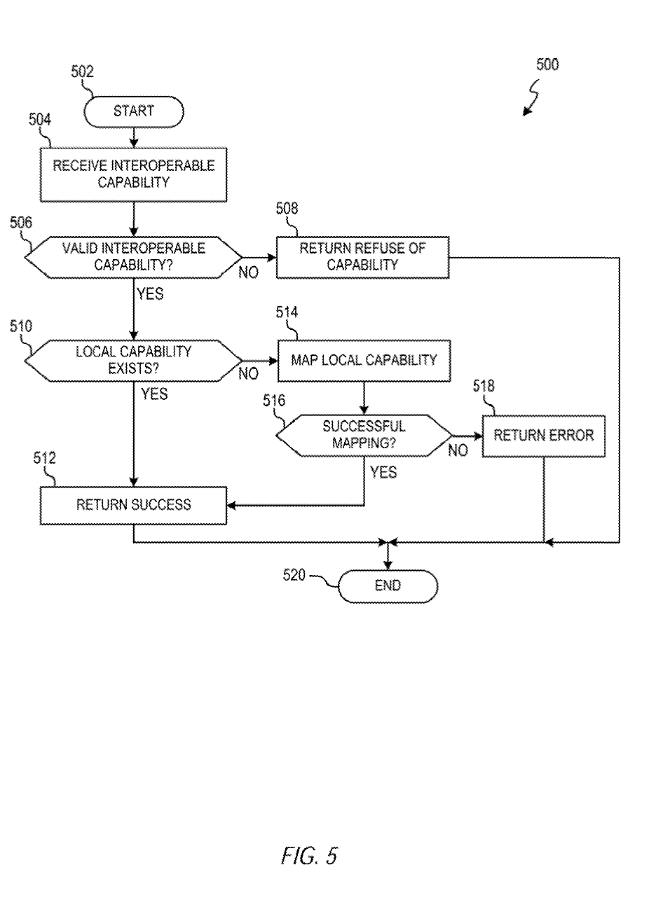

If the corresponding interoperable capability does exist (“YES” at block 406), the kernel (224-1) at block 408 sends the interoperable capability (218) to the other kernels (224-2, 224-3) for integration by those kernels. An example integration process will be described further herein below with reference to FIG. 5. At block 410, the kernel (224-1) receives answer messages from the other kernels (224-2, 224-3) indicating success or failure of the integration process.

Referring again to block 406, if the kernel (224-1) determines that an interoperable capability corresponding to the local capability (214-1) created at block 404 does not exist (“NO” at block 406), method 400 proceeds to block 412, where the kernel (224-1) determines whether the local capability refers to a global resource (i.e., a shared resource of the system accessible by all kernels). If the local capability does not refer to a global resource (“NO” at block 412), method 400 proceeds to block 414, where the kernel (224-1) returns an indication of failure to create an interoperable capability. In some implementations, an interoperable capability may not be needed if no shared or global resources are implicated by the local capability created at block 404.

If the local capability does refer to a global resource (“YES” at block 412), method 400 proceeds to block 416, where the kernel (224-1) allocates an interoperable capability. For example, the kernel (224-1) may allocate a fixed or minimum amount of space in shared memory (e.g., persistent memory pool 216) for an interoperable capability, such as in a capability table. At block 418, the kernel (224-1) determines whether the system (200) had insufficient capability space to allocate to an interoperable capability at block 416. If the system 200 is out of capability space (“YES” at block 418), the kernel (224-1) returns a failure to create an interoperable capability at block 414.

If the system 200 has capability space (“YES” at block 418), method 400 proceeds to block 420, where the kernel (224-1) translates the local capability (214-1) to an interoperable capability (218). For example, the interoperable capability (218), block 420 may include writing the memory representation of the interoperable capability into the allocated space (e.g., a memory representation similar to the memory layout of the interoperable capability 218 described above with reference to FIG. 2) and associating the local representation (214-1) with the interoperable capability (218) using, for example, a reference system described above with respect to FIG. 3A, 3B, or 3C. After block 420, the kernel (224-1) sends the newly created interoperable capability (208) to the other kernels (224-2, 224-3) for integration at block 408 and awaits an answer from the other kernels (224-2, 224-3) at block 410. After block 410 or block 414 is performed as the case may be, method 400 ends at block 422.

FIG. 5 is a flow diagram depicting an example method 500 for integrating an interoperable capability with a local capability system of a kernel, according to an implementation. As with method 400, method 500 may be implemented in the form of executable instructions stored on a machine readable medium and executed by a processing resource and/or in the form of electronic circuitry. Method 500 may be described below as being performed by kernels 224 running on the processing resource 220 (comprising nodes 222) of system 200 and communicating via inter-node messaging, although method 500 may also be performed by other devices (e.g., kernels 124). In some implementations, one or more blocks of method 500 may be executed substantially concurrently or in a different order than shown in FIG. 5, method 500 may include more or fewer blocks than are shown in FIG. 5, and one or more of the blocks of method 500 may be ongoing and/or may repeat.

Method 500 may begin at block 502, and continue to block 504, where a kernel (e.g., 224-2) receives an interoperable capability (e.g., 218) from another kernel (e.g., 224-1). For example, the interoperable capability (218) may have been sent by the other kernel (224-1) according to block 408 described above.

At block 506, the kernel (224-2) determines whether the interoperable capability (218) is valid. For example, in some cases, certain aspects of the interoperable capability (e.g., certain QoS guarantees) may be incompatible with or not supported by the receiving kernel (224-2), and thus invalid. For example, the kernel (224-2) receiving the interoperable capability may be of a different type or version than the kernel (224-1) that created and sent the interoperable capability (218), and thus the receiving kernel (224-2) may not support aspects, operations, or the format of the interoperable capability (218). If the kernel (224-2) deems the interoperable capability (218) to be invalid (“NO” at block 506), the kernel (224-2) returns a refuse of capability at block 508 and method 500 ends at block 520. The refuse of capability message may be received by the sending kernel (224-1) at block 410, in some implementations.

If the kernel (224-2) deems the interoperable capability (218) to be valid (“YES” at block 506), method 500 proceeds to block 510, where the kernel (224-2) checks whether a local capability already exists that corresponds to the interoperable capability (218). For example, another kernel (e.g., 224-3) may have previously sent an instance of the interoperable capability (218). If the local capability (e.g., 214-2) already exists (“YES” at block 510), the kernel returns a success message at block 512. This success message may be received by the sending kernel (224-1) at block 410, in some implementations. In some implementations, the kernel (224-1) may update the mapping between the existing local capability (214-2) and the interoperable capability (218).

If the local capability does not exist (“NO” at block 510), method 500 proceeds to block 514, where the kernel (224-2) maps a local capability (e.g., 214-2) to the interoperable capability (218). If the mapping was successful (“YES” at block 516), the kernel (224-2) returns a success message at block 512 to indicate that the interoperable capability (218) has been integrated into the local capability system of the kernel (224-2). If the mapping was unsuccessful for any reason (“NO” at block 516), the kernel (224-2) returns an error message at block 518 (which may include a reason for mapping failure), which may be subsequently received by the sending kernel (224-1) at block 410 for example. After block 512 or block 518 is performed as the case may be, method 500 may end at block 520.

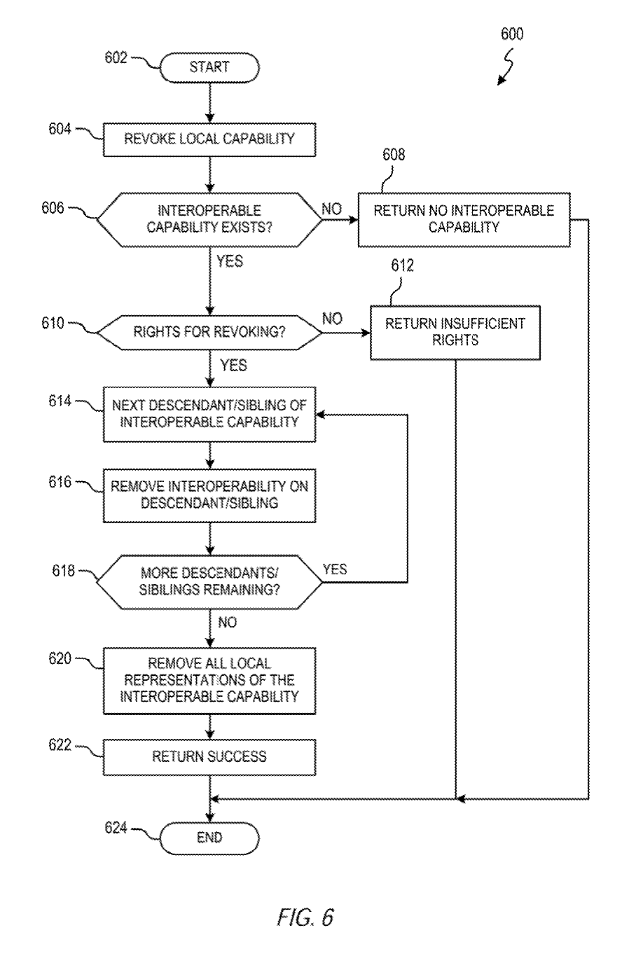

FIG. 6 is a flow diagram depicting an example method 600 for revoking an interoperable capability, according to an implementation. As with methods 400 and 500, method 600 may be implemented in the form of executable instructions stored on a machine readable medium and executed by a processing resource and/or in the form of electronic circuitry. Method 600 may be described below as being performed by kernels 224 running on the processing resource 220 (comprising nodes 222) of system 200 and communicating via inter-node messaging, although method 600 may also be performed by other devices (e.g., kernels 124). In some implementations, one or more blocks of method 600 may be executed substantially concurrently or in a different order than shown in FIG. 6, method 600 may include more or fewer blocks than are shown in FIG. 6, and one or more of the blocks of method 600 may be ongoing and/or may repeat.

Method 600 may begin at block 602, and continue to block 604, where a kernel (e.g., 224-1) invokes a revoke operation on a local capability (e.g., 214-1). Method 600 may be useful for providing a kernel (e.g., 224-1) exclusive access to system resources by deleting all other local capabilities of other kernels that access those resources. At block 606, the kernel (224-1) determines whether an interoperable capability exists that corresponds to and is mapped to the local capability (214-1) to be revoked. If there is no corresponding interoperable capability (“NO” at block 606), the kernel (224-1) returns a no interoperable capability message at block 608, and method 600 may end at block 624.

If there is a corresponding interoperable capability (e.g., 218) (“YES” at block 606), method 600 proceeds to block 610, where the kernel (224-1) checks if it has revocation rights permitted by the interoperable capability (218). For example, the kernel (224-1) may check the authority and/or access rights properties listed in the interoperable capability (218). If the kernel (224-1) does not have revocation rights to the interoperable capability (218), the kernel (224-1) returns an insufficient rights message at block 612, and method 600 may end at block 622.

If the kernel (224-1) has revocation rights in the interoperable capability (218), method 600 proceeds to block 616, where the kernel (224-1) finds the next descendant or sibling capability of the interoperable capability (218). At block 616, the kernel (224-1) removes or deletes any local and interoperable representations of the descendant or sibling capability. At block 618, the kernel (224-1) determines whether there are any more descendants or siblings of the interoperable capability (218) remaining. If there are more descendants or siblings (“YES” at block 618), method 600 returns to block 614, and the kernel (224-1) repeats blocks 614, 616, 618 to remove descendants and siblings until no more remain.

If there are no more descendants or siblings (“NO” at block 618), method 600 proceeds to block 620, where the kernel (224-1) removes all other local representations (e.g., 214-2, 214-3) of the interoperable capability (218). At block 622, the kernel 224-1 returns a success message. Thus, after block 622, the revocation method 600 has resulted in a single capability (214-1) referring to the associated resource (i.e., resource access exclusivity), owing to copies of the capability or derived capabilities (siblings and children) having been removed or deleted. In some implementations, the interoperable capability (218) may remain. After block 622, 612, or 608 is performed as the case may be, method 600 ends at block 624.

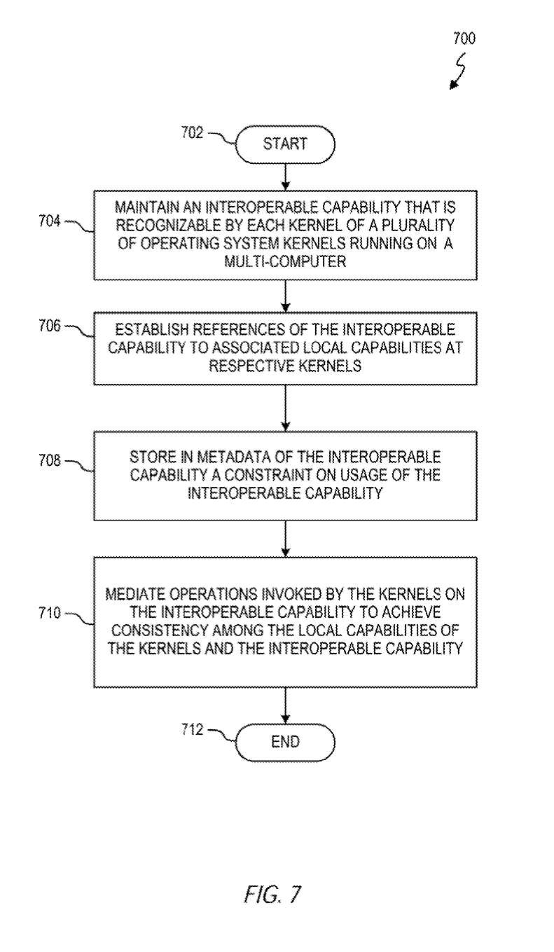

FIG. 7 is a flow diagram depicting an example method 700 for maintaining an interoperable capability, according to an implementation. As with methods 400, 500, and 600, method 700 may be implemented in the form of executable instructions stored on a machine readable medium and executed by a processing resource and/or in the form of electronic circuitry. Method 700 may be described below as being performed by a multi-computer, and system 100 or 200 may be or form part of such a multi-computer. In some implementations, one or more blocks of method 700 may be executed substantially concurrently or in a different order than shown in FIG. 7, method 700 may include more or fewer blocks than are shown in FIG. 7, and one or more of the blocks of method 700 may be ongoing and/or may repeat.

Method 700 starts at block 702 and proceeds to block 704, where a multi-computer maintains an interoperable capability that is recognizable, at least in part, by each kernel of a plurality of operating system kernels running on the multi-computer. In some implementations, block 704 may include creating the interoperable capability (e.g., in a manner similar at least in part to method 400). At block 706, the multi-computer establishes references of the interoperable capability to associated local capabilities at respective kernels. For example, the references may be established by including in the interoperable capability a reference to an array of references to the local capabilities (e.g., in a manner similar to that described above with reference to FIG. 3A), by inlining into the interoperable capability pointers to the local capabilities (e.g., in a manner similar to that described above with reference to FIG. 3B), or by inlining the local capabilities themselves into the interoperable capability (e.g., in a manner similar to that described above with reference to FIG. 3C).

At block 708, the multi-computer stores, in metadata of the interoperable capability, a representation of a resource of the multi-computer accessed via the interoperable capability. The multi-computer also stores a constraint on usage of the resource, where the constraint is to be observed by each kernel using the interoperable capability. In some implementations, the constraint may relate to liveness, persistence, or quality of service or the resource of the multi-computer. By virtue of performing block 708, guarantees on capabilities may be established that cross kernel boundaries.

At block 710, the multi-computer may mediate operations invoked by the kernels on the interoperable capability to achieve consistency among the local capabilities of the kernels and the interoperable capability (i.e., local-local consistency and local-interoperable consistency). For example, the multi-computer may employ various techniques such as consensus protocols to achieve consensus among the kernels on an order in which to execute the operations, forwarding the invoked operation to a kernel that owns the interoperable capability, or enforcing all kernels to execute the operation on respective local representations of the interoperable capability. At block 712, method 700 may end.

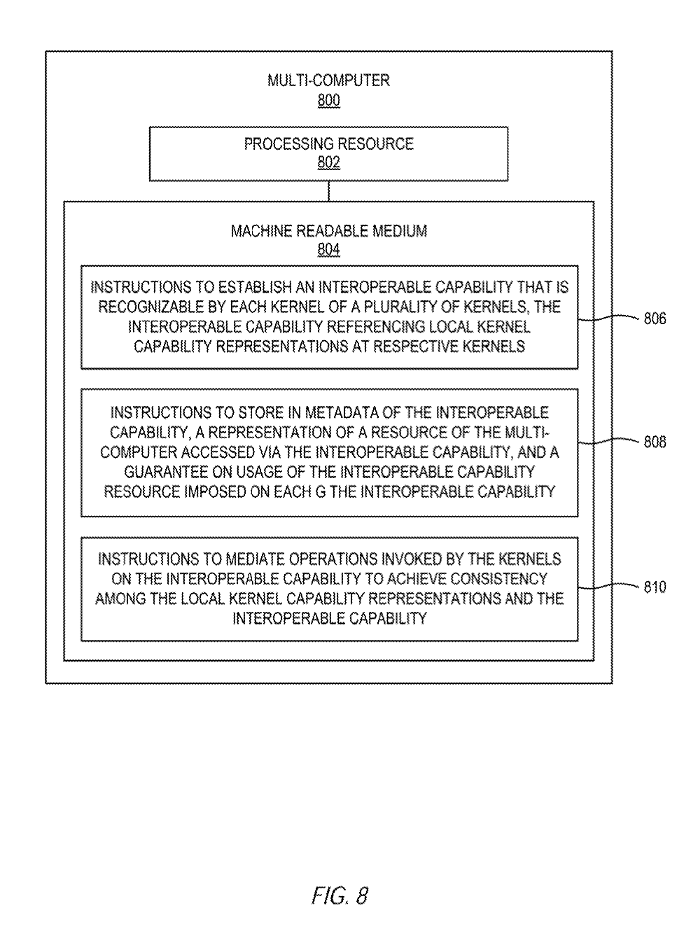

FIG. 8 is a block diagram of an example multi-computer system 800 that includes a processing resource 802 coupled to a non-transitory, machine readable medium 804 encoded with example instructions to establish an interoperable capability. The processing resource 802 may include a microcontroller, a microprocessor, central processing unit core(s), an ASIC, an FPGA, and/or other hardware device suitable for retrieval and/or execution of instructions from the machine readable medium 804 to perform functions related to various examples. Additionally or alternatively, the processing resource 802 may include electronic circuitry for performing the functionality of the instructions described herein.

In some implementations, the processing resource 802 may be analogous to the processing resource 220 described above, and may form part of a plurality of nodes of the multi-computer 800, in a manner similar to the nodes 222. The processing resource 220 may run a plurality of kernels (analogous to kernels 224 described above), some of which differ in type, version, instance, etc.

The machine readable medium 804 may be any medium suitable for storing executable instructions, such as RAM, ROM, EEPROM, flash memory, a hard disk drive, an optical disc, or the like. In some example implementations, the machine readable medium 804 may be a tangible, non-transitory medium, where the term “non-transitory” does not encompass transitory propagating signals. The machine readable medium 804 may be disposed within the multi-computer 800, as shown in FIG. 8, in which case the executable instructions may be deemed “installed” or “embedded” on the multi-computer 800. Alternatively, the machine readable medium 804 may be a portable (e.g., external) storage medium, and may be part of an “installation package.”

As described further herein below, the machine readable medium 804 may be encoded with a set of executable instructions 806, 808, 810. It should be understood that part or all of the executable instructions and/or electronic circuits included within one box may, in alternate implementations, be included in a different box shown in the figures or in a different box not shown. In some implementations, the instructions 806, 808, 810 may be included in or employed by a plurality of different kernels running on the processing resource 802 of the multi-computer 800, in a manner similar to the kernels 224 described above.

Instructions 806, when executed by the processing resource 802, establish an interoperable capability that is recognizable by each kernel of a plurality of kernels running on the multi-computer. For example, the interoperable capability may be analogous in many respects to the previously described interoperable capability 218. The local kernel capability representations also may be analogous in many respects to the previously described local capabilities 214. In some implementations, the local kernel capability representations may be accessible solely by respective kernels. Additionally, instructions 806 may establish references between the interoperable capability and local kernel capability representations of respective kernels. For example, the references may be established, at least in part, in a manner analogous to a reference system described above with respect to FIG. 3A, 3B, or 3C.

Instructions 808, when executed by the processing resource 802, store in metadata of the interoperable capability, a representation of a resource of the multi-computer 800 accessed via the interoperable capability and a guarantee (also referred to as a constraint) on usage of the resource that is imposed on each kernel accessing and/or using the interoperable capability.

Instructions 810, when executed by the processing resource 802, mediate operations invoked by the kernels of the multi-computer 800 on the interoperable capability to achieve consistency among the local kernel capability representations and the interoperable capability (i.e., local-local consistency and local-interoperable consistency). In some implementations, instructions 810 include instructions to achieve consensus among the kernels on an order in which to execute the operations, using consensus protocols for example. In some implementations, instructions 810 include instructions to forward each invoked operation to a capability owner from among the kernels that has authority to execute the operation on the interoperable capability. In some implementations, instructions 810 include instructions to enforce each of the kernels of the multi-computer 800 to execute the operations on respective local kernel capability representations.

In view of the foregoing description, it can be appreciated that an interoperable capability enables different kernels to use and re-use capabilities across node and kernel boundaries in a multi-computer system, while observing system-wide guarantees and achieving consistency with respect to operations performed on capabilities. Moreover, employing interoperable capabilities may provide compatibility and interoperability between different operating systems without needing to modify existing capability formats.

In the foregoing description, numerous details are set forth to provide an understanding of the subject matter disclosed herein. However, implementation may be practiced without some or all of these details. Other implementations may include modifications and variations from the details discussed above. It is intended that the following claims cover such modifications and variations.

What is claimed:

1. A system comprising:
memory to store an interoperable capability and local capabilities, wherein the interoperable capability is accessible by a plurality of operating system kernels, each local capability belongs to a respective kernel and is formatted in a representation specific to the respective kernel, and the interoperable capability references the local capability of each kernel; and
a processing resource to:
run the kernels, each kernel maintaining a mapping of the local capability of the each kernel to the interoperable capability, and
maintain consistency among the local capabilities of the kernels and the interoperable capability in response to invocation of an operation on the interoperable capability.

2. The system of claim 1, wherein the interoperable capability is stored in a persistent and shared portion of the memory accessible to all of the kernels, and
the local capability of each kernel is stored in a portion of the memory local to the each kernel.

3. The system of claim 1, wherein the interoperable capability is of a fixed size and includes a reference to a list of pointers that point to local capabilities

4. The system of claim 1, wherein the interoperable capability includes inlined references to local capabilities.

5. The system of claim 1, wherein the interoperable capability includes inlined local capabilities.

6. The system of claim 1, wherein the processing resource is to maintain consistency by achieving consensus among the kernels to execute the operation.

7. The system of claim 1, wherein the processing resource is to maintain consistency by forwarding invocation of the operation to a capability owner from among the kernels, the capability owner having authority to execute the operation on the interoperable capability.

8. The system of claim 1, wherein the processing resource is to maintain consistency by enforcing each of the kernels to execute the operation on respective local capabilities.

9. The system of claim 1, wherein the interoperable capability includes metadata that indicates a constraint on usage of the interoperable capability, and each kernel observes the constraint when using the interoperable capability.

10. A method comprising:
maintaining, by a multi-computer, an interoperable capability that is recognizable by each kernel of a plurality of operating system kernels running on the multi-computer;
establishing, by the multi-computer, references of the interoperable capability to associated local capabilities at respective kernels;
storing, by the multi-computer and in metadata of the interoperable capability,
a representation of a resource of the multi-computer accessed via the interoperable capability, and
a constraint on usage of the resource observed by each kernel when using the interoperable capability, and
mediating, by the multi-computer, operations invoked by the kernels on the interoperable capability to achieve consistency among the local capabilities of the kernels and the interoperable capability.

11. The method of claim 10, wherein the mediating includes achieving consensus among the kernels on an order in which to execute the operations.

12. The method of claim 10, wherein the constraint relates to liveness, persistence, or quality of service or the resource of the multi-computer.

13. The method of claim 10, wherein the establishing references includes:
including, in the interoperable capability, a reference to an array of references to the local capabilities,
inlining the local capabilities into the interoperable capability, or
inlining, into the interoperable capability, pointers to the local capabilities.

14. A non-transitory machine readable medium storing instructions executable by a processing resource of a multi-computer, the non-transitory machine readable medium comprising:
instructions to establish an interoperable capability that is recognizable by each kernel of a plurality of kernels running on the multi-computer, the interoperable capability referencing local kernel capability representations of respective kernels;
instructions to store in metadata of the interoperable capability, a representation of a resource of the multi-computer accessed via the interoperable capability, and a guarantee on usage of the resource that is imposed on each kernel using the interoperable capability; and
instructions to mediate operations invoked by the kernels on the interoperable capability to achieve consistency among the local kernel capability representations and the interoperable capability.

15. The non-transitory machine readable medium of claim 14, wherein the instructions to mediate operations includes:
instructions to achieving consensus among the kernels on an order in which to execute the operations,
instructions to forward each invoked operation to a capability owner from among the kernels that has authority to execute the operation on the interoperable capability, or
instructions to enforce each of the kernels to execute the operations on respective local kernel capability representations.
